(19) United States
(12) Patent Application Publication
(10) Pub. No.: US 2009/0071267 A1
(43) Pub. Date: Mar. 19, 2009

(54) PIPETTE TIP EJECTION MECHANISM

(76) Inventors: Greg Mathus, Concord, MA (US); Richard Cote, Bolton, MA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/856,193

(22) Filed: Sep. 17, 2007

(51) Int. Cl. G01N 1/14; B01L 3/02

(52) U.S. Cl. 73/864.14; 422/100

(57) ABSTRACT

An ejection mechanism for a hand-held pipettor provides for varying degrees of mechanical advantage along the stroke of the ejector button. The ejection mechanism can be used for either hand-held single channel pipettors or hand-held multi-channel pipettors having manually actuated ejection mechanisms.

### FIELD OF THE INVENTION

The invention relates to improvements in pipettors. More specifically, the invention relates to a manual pipette tip ejection mechanism.

### BACKGROUND OF THE INVENTION

The use of disposable pipette tips with pipettors is well known. Disposable pipette tips enable repeated use of pipettors to transfer different fluids or different fluid samples without carryover contamination. Disposable pipette tips are normally formed of a plastic material, such as polypropylene, and have a hollow, elongated, generally conical shape. The upper end of the pipette tip typically includes a collar which is mounted to the tip mounting shaft on the pipettor. The mounting shaft includes an internal bore through which air is displaced in order to aspirate liquid sample into and dispense liquid sample from the pipette tip. The far end of the pipette tip has a small opening through which liquid sample is received into and dispensed from the barrel of the pipette tip.

Disposable pipette tips have historically relied on tapered fits between the mounting shaft and the pipette tip collar, as well as sealing rings on the inside circumference of the pipette tip collar, to secure and seal pipette tips to the mounting shaft. In most cases, the fit between the mounting shaft and the disposable tip is achieved by pushing the tapered mounting shaft into the tapered pipette tip collar until it wedges into the tip. At this point, a seal is achieved between the tip collar and the mounting shaft as a result of crushing the sealing ring and/or stretching the diameter of the collar. In addition to achieving a proper seal, it is also important that position and orientation of the mounted tip also be stable in the face of lateral momentum or slight knocking forces that are typical during normal use, such as during touch-off against the sidewall of a container or well. In order to assure tip stability, users tend to jam the pipette mounting shaft into the tip with excessive force. In such circumstances, a relatively large ejection force is necessary to remove the tips from the mounting shaft.

Many pipettors include manual tip ejection mechanisms. Typical manual ejection mechanisms include an actuator or button located on the front side of the pipette near the normal thumb location for the user when the pipette is grasped with the index finger residing under the finger hook on the back side of the pipettor. For practical operation of the pipettor, as well as long term ergonomic welfare of the users, it is important that the ejection actuator be located properly and also that its stroke and ejection force not be excessive.

Various techniques have been implemented in the prior art in order to reduce the amount of ejection force that needs to be manually applied by the laboratory worker. For example, significant effort has been directed to the design of pipette tips and/or mounting shafts which provide adequate sealing and stability of the pipette tips onto the mounting shafts without requiring excessive mounting and ejection forces. One such system is disclosed in co-pending patent application Ser. No. 11/552,384 entitled “Locking Pipette Tip and Mounting Shaft” which is assigned to the assignee of the present application, and incorporated by reference herein.

On the other hand, some pipettors implement automatic tip ejection mechanism, and some use energy stored in springs or magnets to assist in ejection so that the entire force of ejection does not need to be applied by the user.

Another technique used in some pipettors is to provide a manual ejection mechanism with levers or the like to provide mechanical advantage thereby reducing the amount of force necessary to be provided manually by the user's thumb. One of the primary disadvantages of using mechanical advantage, to date, is that the stroke of the ejector mechanism is substantially reduced compared the stroke of the actuator mechanism. Therefore, the stroke of the ejector actuator or button must be increased in order to provide sufficient stroke for the ejector mechanism at the tip mounting location to assure reliable ejection. Increased stroke of the ejection actuator can be inconvenient and awkward for the user.

### SUMMARY OF THE INVENTION

In one aspect, the invention is a single channel or multi-channel pipettor in which the transmitted ejection force is increased above the amount of force applied to the ejector button via mechanical advantage over a first portion of the range of motion of the ejector button and is not increased via mechanical advantage over a second portion of the range of motion of the ejector button. In this manner, the stroke of the ejector sleeve or multi-channel stripping bar is reduced partially in order to gain mechanical advantage and provide an initial ejection force amplification, yet the stroke is not reduced so much as to jeopardize reliable tip ejection. The preferred structure includes an ejector push bar with a decelerator portion and an accelerator portion. The decelerator portion interacts with a rocker arm that is pivotally mounted to the pipettor and has a downwardly facing lower surface that engages the ejector sleeve or the like in a single channel pipettor or an upper collar for a multi-channel ejecting device, during the upper portion of the range of motion of the ejector button. As the user presses the ejector button downward and the rocker arm pivots to a point that it clears the ejector sleeve collar or the upper collar for the multi-cylinder stripping device. The accelerator portion of the push bar engages the collar of the ejector sleeve or the multi-cylinder ejection device and without mechanical advantage. In this manner, the initial force required is reduced ergonomically, yet the stroke of the ejector sleeve for multi-cylinder stripper bar is sufficient to assure full complete ejection of the one or more pipette tips.

The invention is particularly useful when used in connection with a pipettor having a mounting shaft and disposable pipette tips as disclosed in the above referenced and incorporated copending patent application Ser. No. 11/552,384 entitled “Locking Pipette Tip and Mounting Shaft”. It should be understood, however, that the ejection mechanism is useful with other types of mounting shafts and pipette tips as well, in order to reduce initial ejection forces without unduly limiting stroke of the ejection mechanism.

It is also well known that ejection forces for multi-channel pipettors are typically greater than those for single channel pipettors. Thus, the invention, in one aspect is particularly well suited for multi-channel pipettors. For multi-channel pipettors, it is preferred that the stripper bar include a terraced lower surface such that initiation of ejection of the pipette tips does not begin simultaneously. Preferably, the ejection of the outermost pipette tips or pairs of pipette tips occurs at an instant slightly before the initiation of the next group of pipette tips and so on until the initiation of the centermost pipette tips is initiated. In the most preferred embodiment, the amount of terracing is no greater than the portion of the stroke of the ejector button for which there is provided mechanical advantage.

### BRIEF DESCRIPTION OF THE DRAWINGS

FIG. 1 is a perspective view of a hand-held, electronic air displacement pipettor incorporating a manual tip ejection mechanism in accordance with the invention.

FIG. 2 is a detailed view of components located within a handle portion of the pipettor shown in FIG. 1, showing the components of a manual ejector mechanism constructed in accordance with the invention.

FIG. 3 is a side elevational view of the pipettor shown in FIG. 1 with the housing for the handle portion of the pipettor removed.

FIGS. 4 and 5 are views similar to FIG. 3 showing schematically the operation of the ejector mechanism.

FIG. 6 is a longitudinal cross-sectional view of the pipettor shown in FIG. 1 showing a pipette tip mounted to the mounting shaft of the pipettor.

FIG. 7 is a view similar to FIG. 6 showing the pipette tip being removed from the mounting shaft.

FIG. 8 is another view similar to FIGS. 6 and 7 showing the pipette tip being fully removed from the mounting shaft.

FIG. 9 is a perspective view of a hand-held, multi-channel, electronic air displacement pipettor incorporating an ejector mechanism in accordance with the invention.

FIG. 10 is a view illustrating the components within the handle portion of the multi-channel pipettor in FIG. 9 which illustrates the components of the ejector mechanism.

FIG. 11 is a side elevational view showing internal components of the multi-channel pipettor shown in FIG. 9.

FIG. 12 is an assembly view of various components of the multi-channel pipettor shown in FIG. 9.

FIG. 13 is a schematic view illustrating the operation of the ejector mechanism on the multi-channel pipettor of FIG. 9.

### DETAILED DESCRIPTION OF THE INVENTION

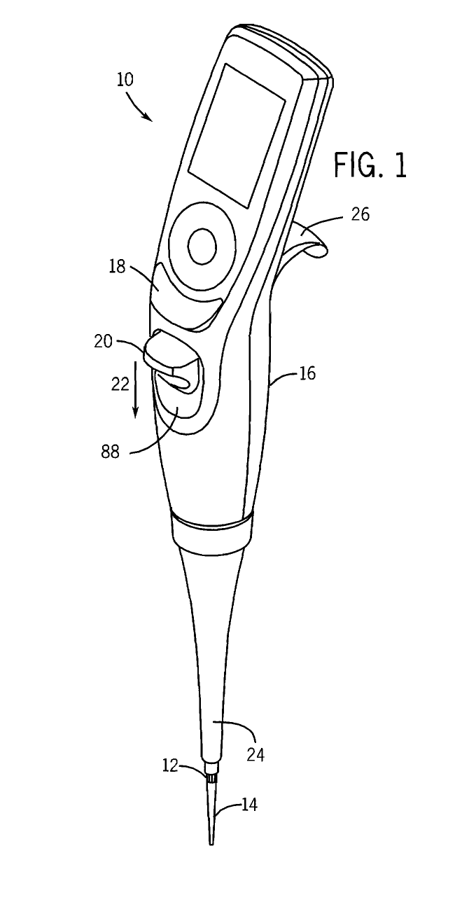

FIG. 1 illustrates a hand-held electronic displacement pipettor 10 that incorporates a pipette tip mounting shaft 12 and a disposable pipette tip 14. The pipettor 10 shown in FIGS. 1-8 is a single channel pipettor 10. The pipettor 10 includes a housing 16 designed to be held in the palm of the user. Internal components of the pipettor (not shown in FIG. 1) drive a piston that extends through a seal assembly to displace air within an aspiration and dispensing cylinder. The pipette tip mounting shaft 12 is threaded or otherwise attached to the lower end of the pipettor such that it is in fluid communication with the aspiration and dispensing chamber. Button 18 is provided for the user to instruct the pipettor 10 to aspirate and dispense. The pipettor also includes ejector button 20 that is actuated in the direction of arrow 22 to move an ejector sleeve 24 in order to eject the disposable pipette tip 14 from the mounting shaft 12.

The ejector sleeve 24 surrounds the aspiration dispensing chamber (not shown in FIG. 1) which is located on the pipettor 10 below the handle portion 16. A finger hook 26 is provided on the back side of the handle portion 16. The housing for the handle portion is preferably made of polycarbonate. In the normal course, a user grasps the handle portion 16 such that their index finger will reside against the underside of the finger hook 26 and that their thumb will be available to conveniently actuate run button 18 and ejector button 20.

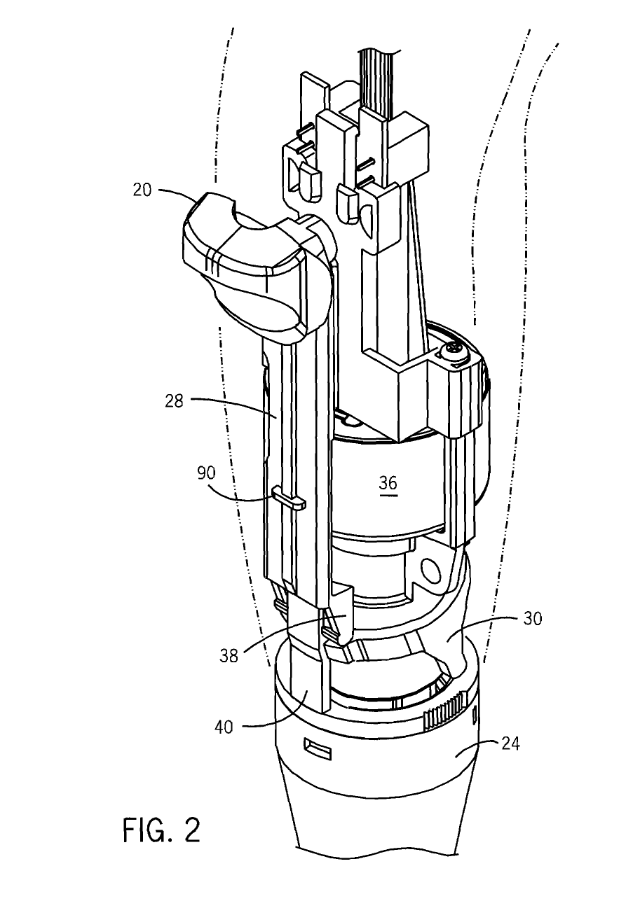

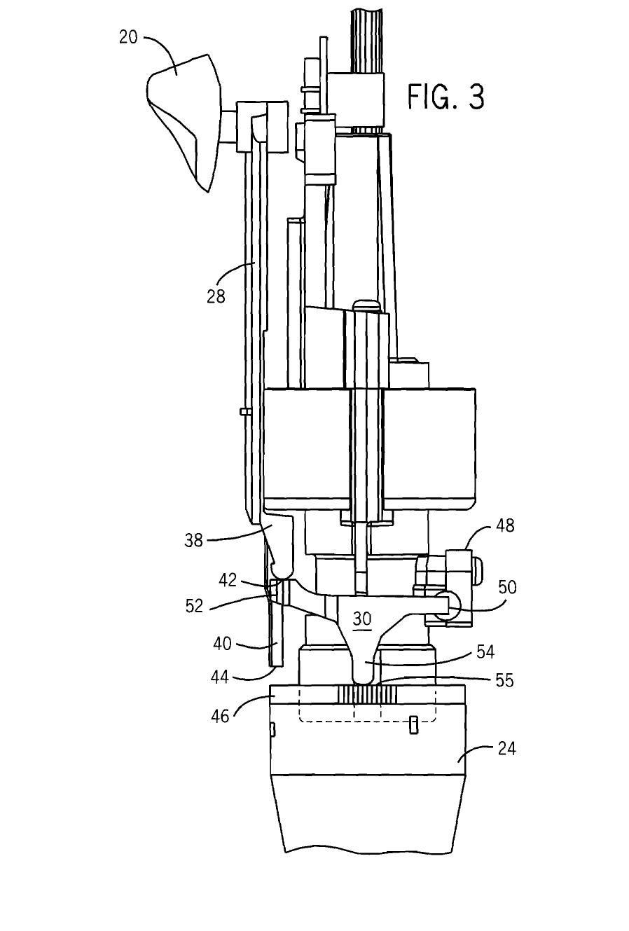

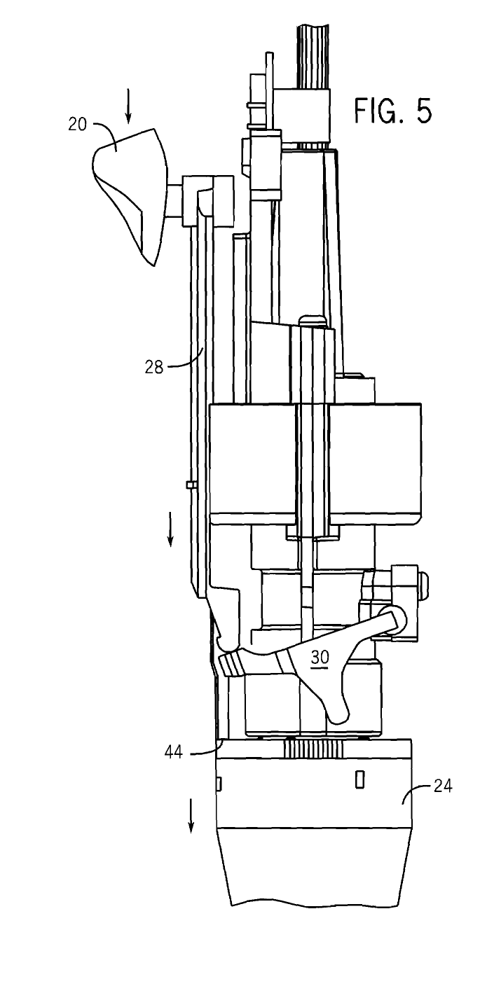

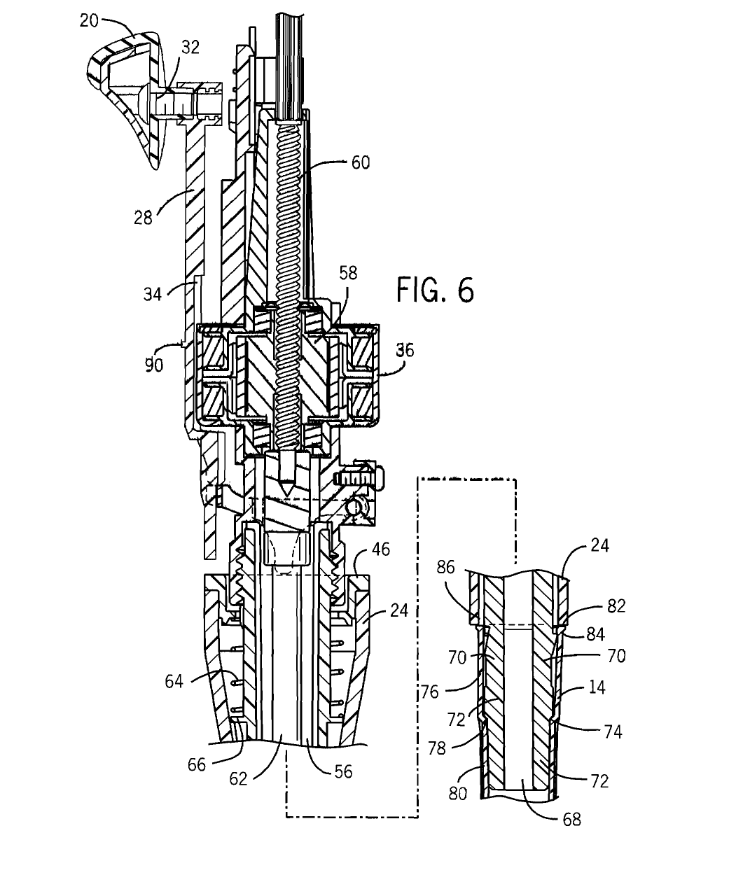

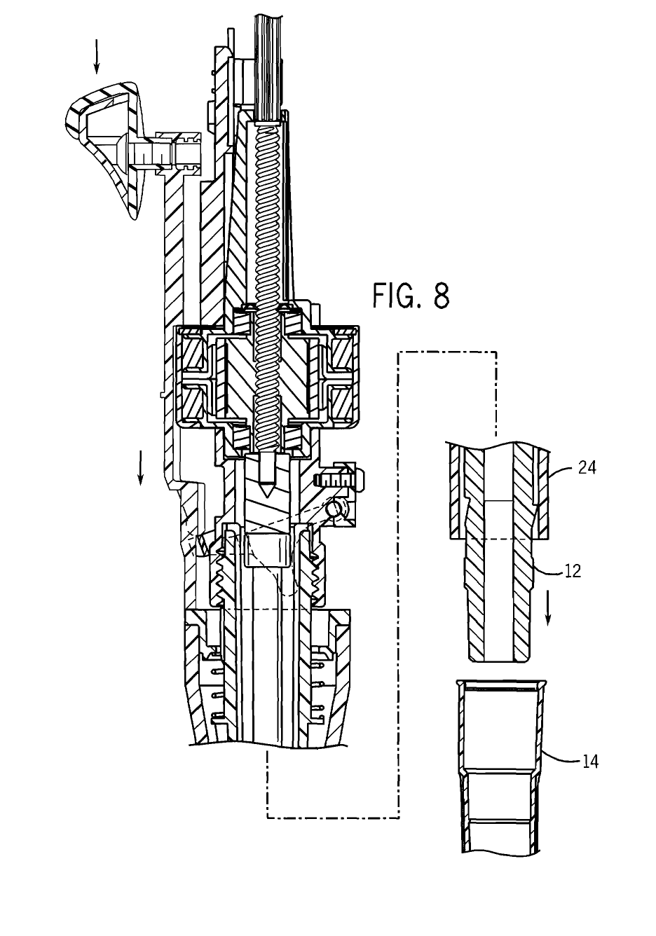

Referring now to FIGS. 2-8, the preferred ejection mechanism generally includes the ejector button 20, an ejector push bar 28, a rocker arm 30 and the ejector sleeve 24. The ejector button 20 is attached to the top end of the push bar 28 using a screw 32 (see FIG. 6). The ejector button 20 is preferably made of molded plastic such as acetal. The preferred stroke of the ejector button 20 from its uppermost position (FIGS. 3 and 6) to its lowermost position (FIGS. 5 and 8) is preferably between 3/16 and ¼ of an inch. The ejection button 20 is located such that its height at the top of its stroke slightly below (i.e. approximately 18 mm/0.7″) the height of the finger hook 26 on the rear side of the pipettor 10. With such a location of the ejector button 20 with respect to the finger hook 26, such a stroke is within the normal range of thumb motion.

The ejector push bar 28 extends vertically downward from the ejector button 20. The push bar 28 is preferably made of fiber-reinforced plastic in order to provide sufficient strength. The shape and configuration of the push bar 28 is confined by space requirements dictated by the amount of space between the housing for the handle portion 16 and the other interior components for the pipette 10. In particular, the push bar includes a cutout 34 (FIG. 6) to provide clearance for the push bar 28 around the motor housing 36.

The ejector push bar 28 is guided vertically by the handle housing 16. In particular, at the top of the push bar 28 the ejector button 20 is guided along the outside surface of a lens 88 located over the outside surface of the handle housing. The material of the actuator button 20, namely acetal, provides lubricity to facilitate sliding of the ejector button 20 against the lens 88. Also, the inside surface of the housing 16 includes inwardly projecting guides (not shown) to help maintain the push bar 28 in its vertical orientation. The tab 90 shown on the outside surface of the push bar 28 serves as a mechanical stop against an inwardly extending tab (not shown) on the inside surface of the handle housing 16, to define the uppermost position for the ejector push bar 28 and ejector button 20.

Referring to FIG. 2, the lower end of the ejector push bar 28 includes a decelerator portion 38 and an accelerator portion 40. Both the decelerator portion 38 and the accelerator portion 40 jog inward towards the bottom of the push bar 28 before extending further downward. The bottom surface of the decelerator portion 38, depicted by reference number 42, is an indirect ejection surface. The bottom surface 44 of the accelerator portion 40 is a direct ejection surface 44. The direct ejection surface 44 on the accelerator portion 40 of the push bar 28 stands above a collar 46 located at the top end of the ejection sleeve 24 when the ejector button 20 is in the uppermost position of its range of motion, see FIGS. 3 and 6.

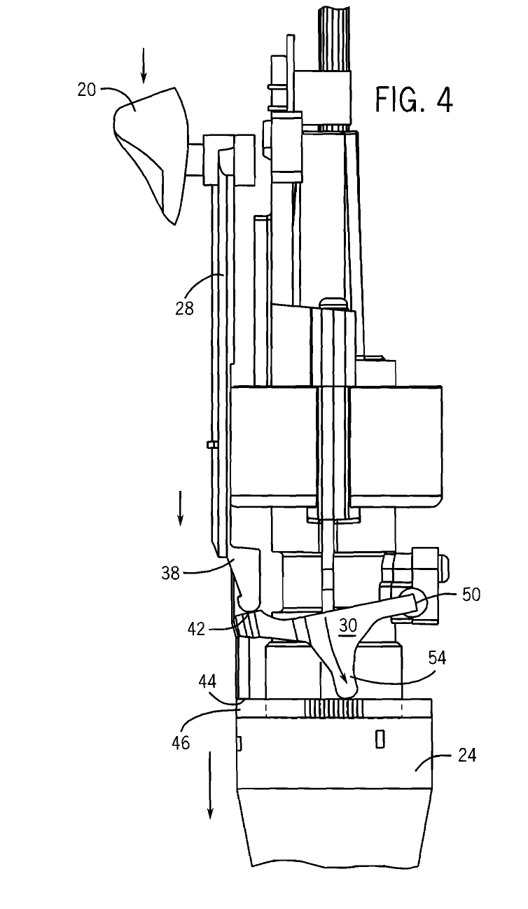

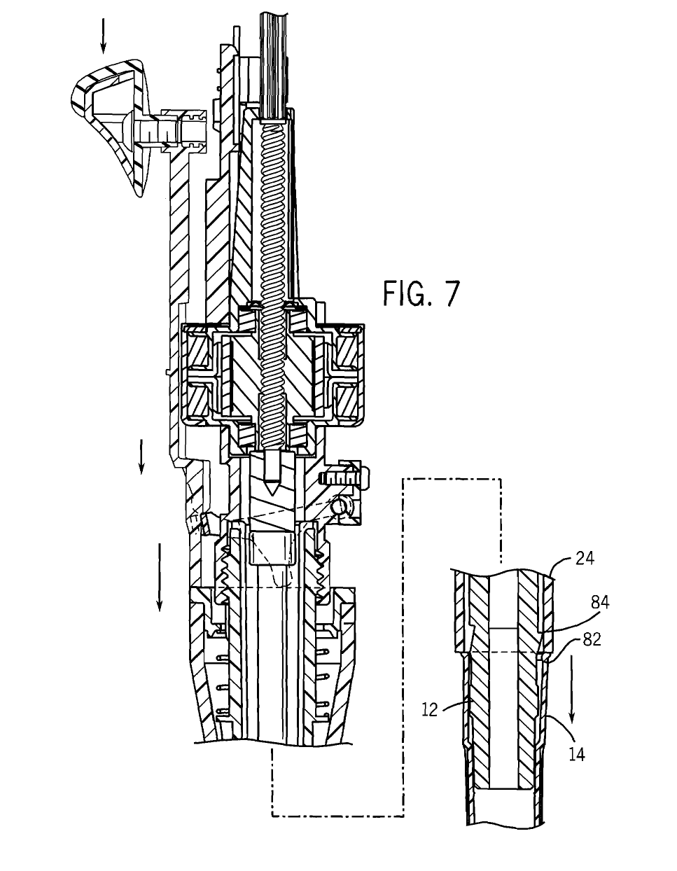

Referring to FIG. 3, the rocker arm 30 is pivotally mounted to the structural frame 48 of the pipette 10. The rocker arm 30 is connected to the frame using a pin at fulcrum 50. The fulcrum 50 is located on the opposite side of the pipette 10 from the ejector button 20. A leg 52 of the rocker arm 30 is adapted to receive the indirect ejection surface 42 of the decelerator portion 38 of the lower end of the push bar 28. As the push bar 28 moves downward, the indirect ejection surface 42 on the decelerator portion 38 pushes downward on the extended leg 52 of the rocker arm 30 to rotate the rocker arm around fulcrum 50. When this occurs, a lower surface 55 on a downward extending cam 54 on the rocker arm 30 presses downward against the collar 46 on the ejector sleeve 24. See, for example, FIGS. 4 and 7. While not shown in the drawings, it is preferred that the rocker arm 30 be symmetric on both sides, right and left, of the pipettor 10. The preferred rocker arm 30, when viewed from the top, is approximately circular, and is pivotally connected to rotate about fulcrum 50. The rocker arm 30 is preferably made of molded plastic, and more preferably made of acetal. In the preferred embodiment, the center line of the cam 54 is located midway between the fulcrum 50 and the point at which the indirect ejection surface 42 of the decelerator portion 38 of the push bar 28 pushes against the extended leg 52 of the rocker arm 30. In this manner, the mechanical advantage provided by use of the rocker arm 30 is approximately 2:1, thereby multiplying the amount of force applied to the ejector sleeve 24 by a factor of 2 compared to the amount of force that is applied to the ejector button 20. The length of the cam 54 is chosen so that, in the preferred embodiment, it clears from the collar surface 46 of the ejector sleeve 24 (see FIGS. 4 and 5) as the direct ejection surface 44 contacts the collar surface 46 on the ejector sleeve while the ejector button 20 and push bar 28 are continued to be pushed downward via normal operation of the ejection mechanism. The clearance of the rocker arm 30 provides a slight over-center feeling to the user. In the preferred embodiment of the invention, the direct ejection surface 44 on the push bar 28 stands above the surface of the collar 46 of the ejector sleeve 24 by approximately one-half of the stroke of the ejector button 20 (e.g. ⅛ of an inch if the ejector button stroke is ¼ of an inch). In this manner, the transmitted ejection force will be increased via mechanical advantage through the rocker arm 30 for approximately one-half of the range of motion of the ejector button 20, and thereafter the direct ejection surface 44 of the push bar 28 will transmit ejection force to the ejector sleeve 24 without mechanical advantage.

The main portion of the ejector sleeve 24 is preferably made of metal, but can also be made of molded plastic, for example molded polypropylene. The upper collar 46 of the ejector sleeve 24 is preferably made of acetal. Referring in particular to FIGS. 6-8, the ejector sleeve 24, as mentioned, surrounds the aspiration cylinder 56 of the pipette 10. The motor 58 located in the motor housing 36 drives a screw 60 to raise and lower the piston 62 located in the aspiration chamber 56 in order to operate the pipette 10. A biasing spring 64 is inserted between an outwardly extending fin 66 on the wall for the aspiration cylinder 56 and the collar 46 of the ejector sleeve 24, see FIG. 6. The spring 64, as is known in the art, provides biasing force to push the collar 46 and the remaining part of the ejector sleeve 24 to which it is attached upward absent downward force applied to the ejector button 20 by the user to eject a pipette tip 14 from the mounting shaft 12. Referring still to FIGS. 6-8, the preferred pipette tip 14 and mounting shaft 12 are described in detail in the incorporated co-pending patent application Ser. No. 11/552,384 entitled “Locking Pipette Tip and Mounting Shaft”. It should be understood, however, that the invention can be used with other types of pipette tips and mounting shafts than those described in the incorporated copending application. With respect to the preferred embodiment, briefly, the mounting shaft 12 is attached to the lower end of the aspiration cylinder 56. The dimensions of the mounting shaft 12 match the dimensions of the pipette tip 14 so that only pipette tips 14 with proper dimensions can fit onto the preferred mounting shaft 12. The mounting shaft 12 contains a central bore 68 that provides for air passage between the aspiration cylinder in the pipettor 10 and the pipette tip 14, as is well known in the art. The mounting shaft 12 includes an upper locking section 70, a lower sealing section 72, and a stop member 74 located between the locking section 70 and the lower sealing section 72. The preferred pipette tip 14 generally consists of a collar 76, a barrel 80 and a circumferential shelf 78 that extends around the inside bore of the tip 14 and connects the lower end of the collar 76 to the upper end of the barrel 80. The upper end of the collar 76 has an opening to receive the pipette mounting shaft 12. The lower end of the barrel 80 has a small opening through which liquid is aspirated into the tip barrel 80 and dispensed from the tip barrel during normal operation of the pipettor 10. The inside surface of the collar 76 preferably includes a circumferential locking ring 82 that is located at or slightly below the top opening for the collar 76. The locking ring 82 extends inward from the inside wall of the collar 76 a slight amount, preferably in the range of 0.001 to 0.010 inches in order to provide a locking fit over lobes 84 on the mounting shaft 12. It is important, however, that the locking ring 82 not extend so far inward to

In order to eject the tip 14, the lower end of the ejector sleeve 24 is pressed against the top of the pipette tip collar 76. As the sleeve moves downward, it pushes on the top of the collar 76 to push the locking ring 82 on the collar 76 over the lobes 84 on the mounting shaft 12, as shown in FIG. 7. When the locking ring 82 clears the peaks of the lobes 84, energy stored in the distorted collar 76 is released and facilitates efficient ejection of the tip 14 from the mounting shaft 12. In addition, the ejector sleeve 24 continues its downward stroke (see FIG. 8) in order to ensure that the tip 14 is completely removed from the mounting shaft 12. As is typical with the ejection of most pipette tips, a greater amount of force is needed during the beginning of the ejection process (for example at FIG. 6) than toward the end of the ejection process (see FIGS. 7 and 8). On the other hand, it is necessary, however, to provide sufficient stroke for the ejector sleeve 24 so that tips 14 are completely ejected. As mentioned, it is preferred that the transmitted ejection force be increased via mechanical advantage through the rocker arm 30 for approximately one-half of the range of motion of the ejector button 20, and thereafter the direct ejection surface 44 on the push bar 28 transmit ejection force to the ejector sleeve 24 without mechanical advantage.

Other mechanical means, such as a gear or pulley system, can be substituted in accordance with the spirit of the invention for the levered rocker arm 30 in order to achieve force enhancement over an initial portion of the ejector button 20 stroke. As another example, the levered rocker arm 30 could be replaced with a suitable mechanical linkage connecting the push bar to the collar. Moreover, while the described embodiment of the invention separates the ejector button stroke into a first range of motion in which mechanical advantage is used to multiply the ejection force applied to the ejector sleeve 24 and a second portion of the stroke in which no mechanical advantage is utilized, it is also possible within the spirit of the invention to break up the range of motion of the ejector button into more portions so that various portions have varying degrees of mechanical advantage. Also, it may be desirable in accordance with the invention to use a mechanism such as a contoured cam surface on the rocker arm 30 (or on the collar 46) to provide for continuously varying mechanical advantage over the stroke of the ejector button 20.

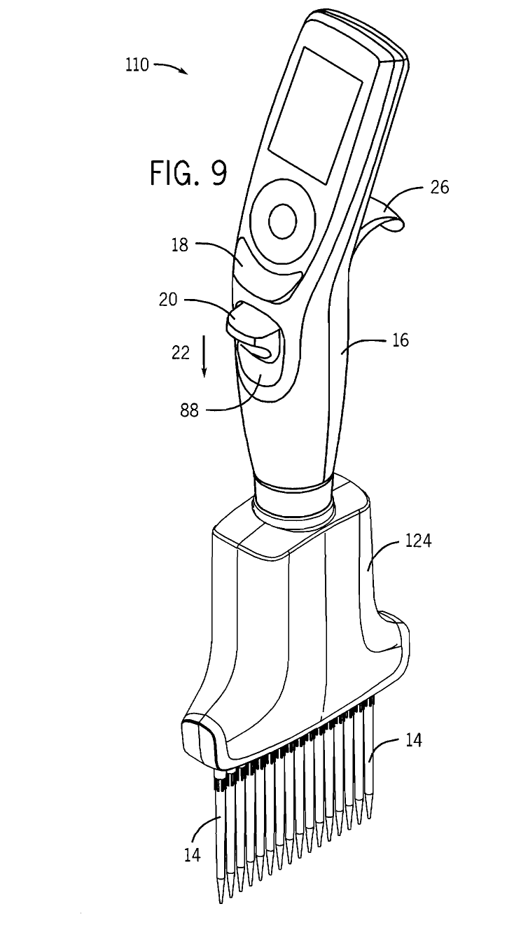

FIGS. 9-13 illustrate a hand-held multi-channel electronic displacement pipettor 110 incorporating an ejector mechanism in accordance with the invention. In many ways, the ejector mechanism, including the rocker arm 30 for the multi-channel pipettor 110 are the same or similar to the components described in connection with the single channel pipettor 10 shown in FIGS. 1-9. By their very nature, multi-channel pipettors 110, as shown in FIGS. 9-13, require greater ejection forces than those required by a single-channel pipettor 10, such as shown in FIGS. 1-9. While many of the components are the same or similar, it may be desirable to make adjustments to accommodate the greater ejection forces necessary for multi-channel pipetting. Similar reference numbers have been used in connection with the multi-channel pipettor 110 in FIGS. 9-13 as were used in FIGS. 1-8 with respect to the single channel pipettor 10 where appropriate.

With respect to the ejection mechanisms, one of the primary differences between the multi-channel pipettor 110 shown in FIGS. 9-13 and the single channel pipettor 10 shown in FIGS. 1-8 is that the multi-channel pipettor 110 uses a multi-channel stripping device rather than an ejector sleeve 24. Note that reference number 124 in FIG. 9 points to the lower component for the multi-channel pipettor 110, and it should be understood that this lower component 124 carries out other functions besides merely ejecting pipette tips 14 from the respective mounting shafts of the multi-channel pipettor 110. For purposes herein, the description of the multi-channel pipettor head 124 will be limited to those aspects relating to the ejection of the pipette tips 14.

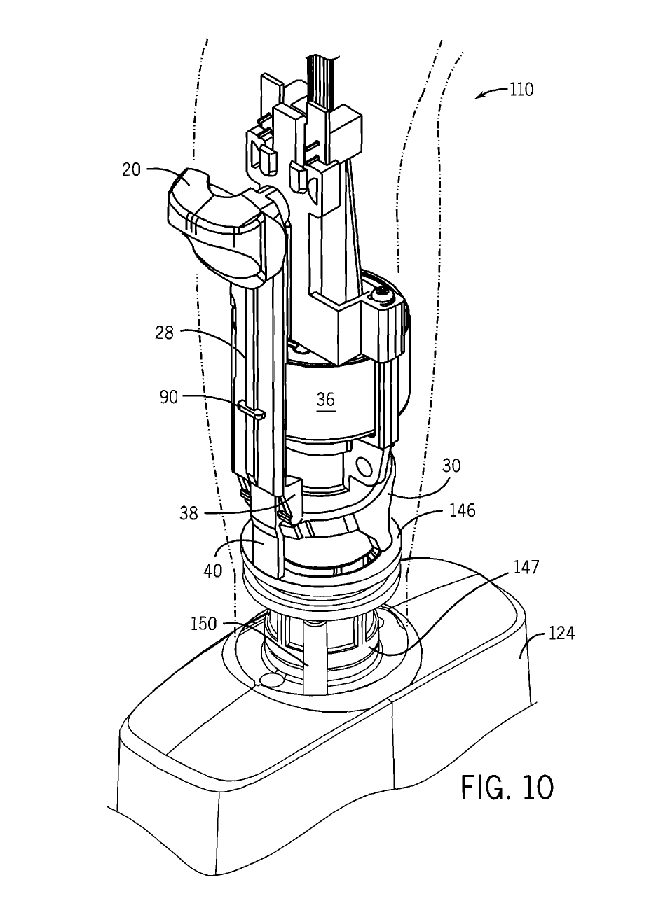

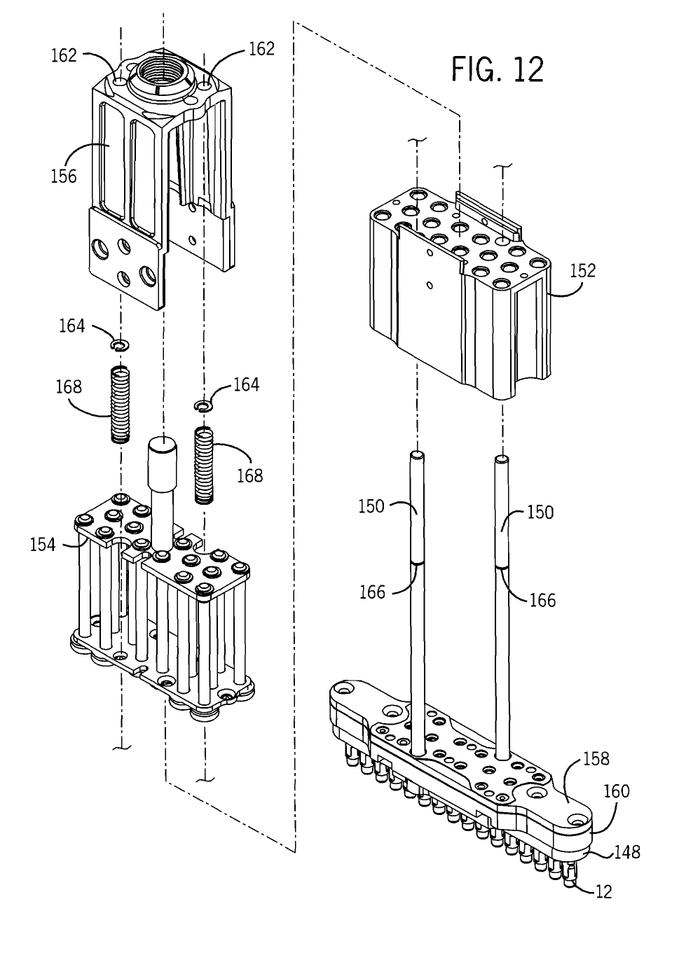

Referring to FIGS. 10-13, the multi-channel stripping device includes an upper collar 146, a stripping bar 148, and force transmission bars 150 connecting the upper collar 146 to the stripper bar 148. Note that the pipettor 110 shown in FIGS. 9-13 is a 16-channel pipettor which has sixteen mounting shafts 12 (see FIG. 12) for mounting sixteen pipette tips 14. Of course, multi-channel pipettors 110 can be made having eight channels or twelve channels, rather than sixteen channels, or any other number of channels desirable.

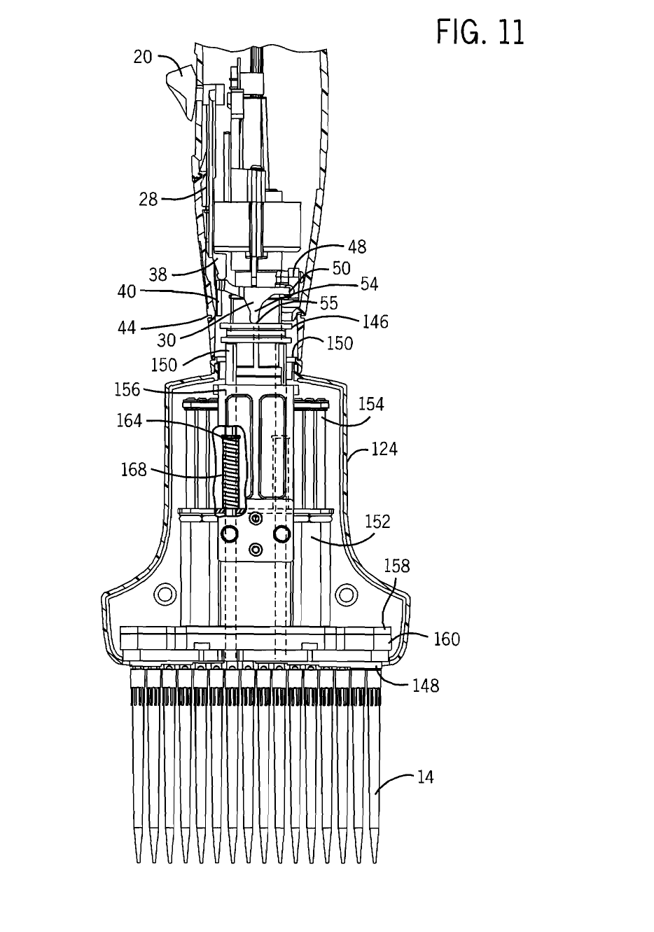

Referring in particular to FIGS. 11 and 12, the multi-channel pipettor head 124 includes a multi-channel piston assembly 154 and a multi-channel cylinder assembly 152 which are mounted to an internal frame 156. Upper and lower manifold plates 158, 160 are attached to the cylinder block 152. The force transmission bars 150 for the ejection mechanism are connected at their lower end to the stripper bar 148, with one bar located towards the front of the pipettor head 124 and the other bar located towards the rear of the head 124. The force transmission bars 150 extend upwardly through the manifold plates 158, 160, the cylinder block 152, the multi-piston assembly 154, and up through openings 162 in the frame 156. Snap rings 164 reside in grooves 166 on the force transmission bars 150 when the ejection mechanism is fully assembled. Biasing springs 168 are mounted around the force transmission bars 150 between the fixed lower surface of the multi-piston assembly 154 (or alternatively the top of the cylinder block 152) and the snap rings 166 to provide an upward biasing pressure on the force transmission bars 150. The upward biasing force maintains the force transmission bars 150 as well as the stripper bar 148 in their upper most position when there is no downward ejection force being provided by the user via ejector button 20.

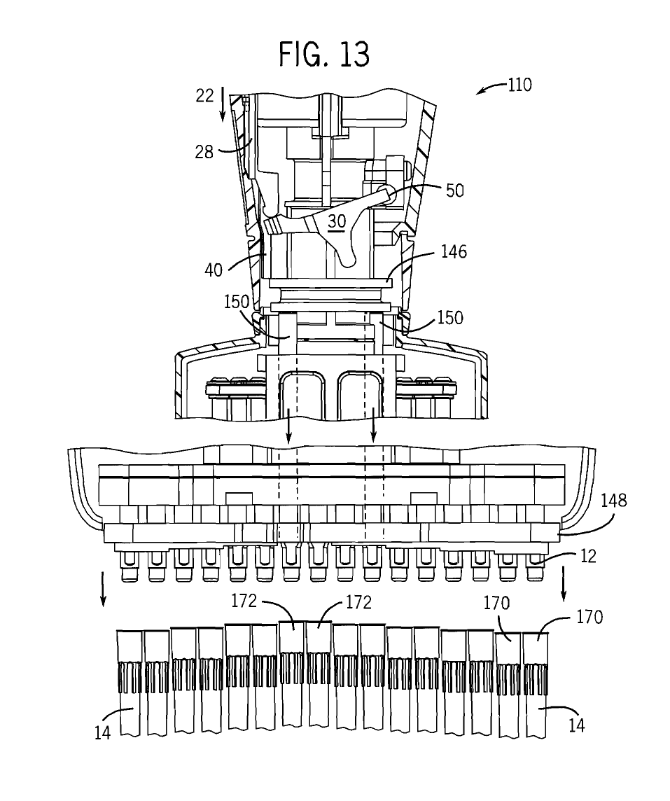

Referring now to FIGS. 10 and 13, in particular, the upper portion of the preferred multi-channel pipettor 110 includes an upper collar 146 which is adapted to transmit the force evenly from the rocker arm 30, or the accelerator portion 40 of the push bar 28 to the pair of force transmission rods 150 for the lower unit 124. As shown in the drawings, the upper collar 146 is slidably mounted over a cylindrical section 147 extending own from the frame of the handle portion of the pipettor 110 between the rocker arm 30 and the force transmission rods bars 150 when the lower unit 124 is attached to the handle portion. Although not shown in the drawings, it has been found to be advantageous to also provide a cylindrical section extending upward from the frame 156 of the lower portion, which fits over the cylindrical section 147 from the handle portion, and then over which the collar 146 is slidably mounted. In either configuration, the collar 146 is free to move coaxially when activated by the rocker arm 30. Also, with either configuration, the user is able to rotate the lower unit 124 with respect to the handle portion, if so desired, without affecting the operation of the collar 146. When the user is not applying pressure to the ejector button 20, the biasing force of the springs 168 biases the force transmission rods 150 upwards, which in turn biases the upper collar 146 and the rocker arm 30 and push bar 28, as well as the ejector button 20, in their uppermost positions.

The schematic drawing in FIG. 13 shows the position of the ejector mechanism towards the lower end or at the bottom of the stroke of the ejector button 20, such that the accelerator portion 40 of the push bar 28 is applying force against the upper collar 146 which in turn applies distributed force along the force transmission bars 150 against the biasing forces of the springs 168, to move the stripper bar 148 downward. As with the single channel embodiment, the transmitted ejection force is increased via mechanical advantage through the rocker arm 30 for approximately one-half of the range of motion of the ejector button 20, and thereafter the accelerator portion of the push bar 28 transmits ejection force without mechanical advantage. As mentioned before, other mechanical means can be substituted in accordance with the spirit of the invention for the levered rocker arm 30 in order to achieve force enhancement over the initial portion of the ejector button 20 stroke. In addition, as also previously mentioned, it may be desirable to break up the range of motion of the ejector button into more portions so that various portions have varying degrees of mechanical advantage, or to use a mechanism such as a contoured cam surface on the rocker arm 30 to provide for a continuously varying mechanical advantage over the stroke of the ejector button 20. In the particular case of multi-channel pipettors 110, as shown in FIG. 13, it is preferred to use a stripper bar 148 having a terraced lower surface so that it engages a first set of one or more pipette tips 14 on the respective mounting shafts 12 as it moves downward to eject pipette tips prior to engaging another set of one or more pipette tips. Note that it is further preferred that the bottom surface of the stripper bar 148 be terraced such that the outermost pipette tips be ejected slightly prior to the innermost pipette tips 172. The terracing of the lower surface of the stripper bar 148 reduces the initial ejection force required by the user.

The drawings, and in particular FIG. 13, shows the amount of terracing in an exaggerated fashion. In practice, it is preferred that the amount of terracing be no greater than, and preferably less than approximately ⅔ than, the clearance between the lower surface of the accelerator portion 40 of the ejector push bar 28 and the top surface of the upper collar 146 when the ejector button 20 is in its uppermost position. With such a configuration, the ejection of each of the pipette tips including the centermost pipette tips will be initiated while the force being transmitted from the ejector button is being increased or enhanced via mechanical advantage.

It is preferred that the upper collar 146 be located in the handle portion 16 of the pipettor 110 so that the upper portion 16 will be able to handle different kinds of lower assemblies.

The spacing between pipette tips 14 for 16-channel pipettors is preferably 4.5 millimeters, whereas the spacing for 8- or 12-channel pipettors is typically 9 millimeters.

We claim:

1. In a hand-held pipettor having a body with a handle portion and an aspiration cylinder located below the handle portion, and having a pipette tip mounting shaft onto which disposable pipette tips are mounted for operation of the pipettor, a pipette tip ejection mechanism comprising:
an ejector sleeve slidably mounted to the body of the pipettor below the handle portion such that the ejection sleeve is movable in a longitudinal direction, a lower edge of the ejection sleeve being movable between an uppermost position in which the edge does not exert ejection force on a pipette tip mounted on the pipette tip mounting shaft and a lowermost position, the lower edge engaging a pipette tip mounted on the mounting shaft and exerting ejection force on the tip to displace and detach the tip from the mounting shaft as it moves along its range of motion from the uppermost position to the lowermost position;
an ejector button connected to the handle portion of the pipettor, the ejector button having a range of motion which is greater than the range of motion of the lower edge of the ejector sleeve;
a spring that biases the ejector button towards an uppermost position of its range of motion as well as the ejector sleeve towards the uppermost position of its range of motion; and
means for transmitting ejection force exerted on the ejector button to move the ejector sleeve downward against the spring biasing force and eject the mounted pipette tip from the mounting shaft, the transmitted force being increased above the amount of force applied to the ejector button via mechanical advantage over a first portion of the range of motion of the ejector button and not being increased via mechanical advantage over second portion of the range of motion of the ejector button.

2. A pipette tip ejection mechanism as recited in claim 1 wherein means for transmitting ejection force comprises:
an ejector push bar that is connected to the ejector button and extends downward, the push bar having an indirect ejection surface and a direct ejection surface; and
a rocker arm having a downward facing lower surface and being pivotally mounted to the pipettor, the indirect ejection surface of the push bar engaging the rocker arm to push the rocker arm downward and press the lower surface on the rocker arm against the ejector sleeve to move the ejector sleeve from its uppermost position towards its lower position for an upper portion of the range of motion of the ejector button, and
wherein the direct ejection surface of the push bar engages the ejector sleeve to move the ejector sleeve towards its lower position for a lower portion of the range of motion of the ejector button.

3. A pipette tip ejection mechanism as recited in claim 2 wherein the lower surface of the rocker arm is located at a position below the direct ejection surface of the push bar when no force is being exerted on the ejector button and the spring has biased the ejector button and the ejector sleeve in their respective uppermost positions.

4. A pipette tip ejection mechanism as recited in claim 3 wherein the lower surface on the rocker arm is in contact with the ejector sleeve when the ejector sleeve is in its uppermost position and there is a spatial gap between the direct ejection surface of the push bar and the ejector sleeve when the ejector sleeve is in its uppermost position.

5. A pipette tip ejection mechanism as recited in claim 1 wherein the mechanical advantage provided by the means for transmitting ejection force during the first portion of the range of motion is 2:1, thereby rendering the stroke of the ejection sleeve during the first portion of the range of motion to be approximately one-half of the stroke to the first portion of the range of motion of the ejector button.

6. A pipette tip ejection mechanism as recited in claim 5 wherein the transmitted force is increased via mechanical advantage for approximately one-half of the range of motion of the ejector button.

7. The invention as recited in claim 1 wherein the pipette tip is a disposable pipette tip having a barrel with a lower opening through which liquid is aspirated into the barrel and dispensed from the barrel, the barrel having a sealing area at an upper end of the barrel, a collar having an upper opening for receiving a pipette tip mounting shaft, the inside surface of the collar including a circumferential locking ring, and the lower end of the collar having a larger inside diameter than the inside diameter of the upper end of the barrel, and a circumferential shelf that connects the lower end of the collar to the upper end of the barrel; and
further wherein the pipette tip mounting shaft includes a lower sealing section, and an upper locking section, the locking section of the mounting shaft including a stop that engages the shelf of a pipette tip when the mounting shaft is fully inserted into the collar of the pipette tip, two or more outwardly extending lobes located above the stop on the mounting shaft for engaging the locking ring on the inside surface of the collar, and relief portions between the lobes such that the collar distorts outwardly at the lobes and inwardly at the relief portion from the pipette tip if locked onto the mounting shaft over the stop and the lobes.

8. In a hand-held, multi-channel pipettor having a body with a handle portion and multiple aspiration cylinders located below the handle portion, and having a pipette tip mounting shaft for each aspiration cylinder to which disposable pipette tips are mounted for operation of the multi-channel pipettor, a pipette tip ejection mechanism comprising:
a multi-channel stripping device which includes an upper collar, a stripper bar, and force transmission bars connecting the upper collar to the stripper bar, wherein the stripper bar is movable between an uppermost position in which the stripper bar does not exert force on pipette tips mounted on the respective pipette tip mounting shafts for multi-channel pipettor and a lowermost position, the stripper bar engaging pipette tips mounted on the respective mounting shafts to displace and detach the tips from the respective mounting shafts as the stripper bar moves from its uppermost position to its lowermost position;
an ejector button connected to the handle portion of the pipettor, the ejector button having a range of motion that is greater than the range of motion of the stripper bar;
a spring that biases the ejector button in an uppermost position and also biases the stripper bar in its uppermost position; and
means for transmitting ejection force exerted on the ejector button to move the stripper bar downward against the spring biasing force and eject the pipette tips from the respective mounting shafts, the transmitted force being increased above the amount of force applied to the ejector button via mechanical advantage over a first portion of the range of motion of the ejector button and not being increased via mechanical advantage over a second portion of the range of motion of the ejector button.

9. A pipette tip ejection mechanism as recited in claim 8 wherein means for transmitting ejection force comprises:
an ejector push bar that is connected to the ejector button and extends downward, the push bar having an indirect ejection surface and a direct ejection surface; and
a rocker arm having a downward facing lower surface and being pivotally mounted to the pipettor, the indirect ejection surface of the push bar engaging the rocker arm to push the rocker arm downward and press the lower surface on the rocker arm against the upper collar of the multi-channel stripping device to move the stripper bar from its upper position towards its lower position for an upper portion of the range of motion of the ejector button; and
wherein the direct ejection surface of the push bar engages the upper collar of the multi-channel stripping device to move the stripper bar towards its lower position for a lower portion of the range of motion of the ejector button.

10. A pipette tip ejection mechanism as recited in claim 9 wherein the lower surface of the rocker arm is located at a position below the direct ejection surface of the push bar when no force is being exerted on the ejector button and the spring has biased the ejector button and the stripper bar in their respective uppermost positions.

11. A pipette tip ejection mechanism as recited in claim 9 wherein the lower surface on the rocker arm is in contact with the upper collar of the multi-channel stripping device when the stripper bar is in its uppermost position and there is a spatial gap between the direct ejection surface of the push bar and the upper collar when the stripper bar is in its uppermost position.

12. A pipette tip ejection mechanism as recited in claim 8 wherein the mechanical advantage provided by the means for transmitting ejection force during the first portion of the range of motion is 2:1, thereby rendering the stroke of the stripper bar during the first portion of the range of motion to be approximately one-half of the stroke to the first portion of the range of motion of the ejector button.

13. A pipette tip ejection mechanism as recited in claim 8 wherein the transmitted force is increased via mechanical advantage for approximately one-half of the range of motion of the ejector button.

14. An ejection mechanism as recited in claim 8, wherein the stripper bar contains a terraced lower surface so that it engages a first set of one or more pipette tips mounted on the respective mounting shafts as it moves downward to ejected pipette tips prior to engaging another set of one or more pipette tips.

15. The invention as recited in claim 8 wherein the disposable pipette tips have a barrel with a lower opening through which liquid is aspirated into the barrel and dispensed from the barrel, the barrel having a sealing area at an upper end of the barrel, a collar having an upper opening for receiving the respective pipette tip mounting shaft, the inside surface of the collar including a circumferential locking ring, and a lower end of the collar having a larger inside diameter than the inside diameter of the upper end of the barrel, and a circumferential shelf that connects the lower end of the collar to the upper end of the barrel; and
each of the respective pipette tip mounting shafts includes a lower sealing section and an upper locking section, the locking section of the respective mounting shaft including a stop that engages the shelf of a pipette tip when the mounting shaft is fully inserted into the collar of the respective pipette tip, two or more outwardly extending lobes located above the stop on the mounting shaft for engaging the locking ring on the inside surface of the pipette tip collar, and relief portions between the lobes such that the pipette tip collar distorts outwardly at the lobes and inwardly at the relief portions when the pipette tip is locked onto the respective mounting shaft over the stop and the lobes.

16. In a hand-held pipettor having a body with a handle portion and one or more aspiration cylinders located below the handle portion and one or more pipette tip mounting shafts onto which one or more disposable pipette tips are mounted for operation of the pipettor, and further having a pipette tip ejection mechanism including an ejector sleeve or stripper bar to engage pipette tips mounted on the respective one or more mounting shafts to displace and detach the tips from the one or more mounting shafts, an ejector button connected to the handle portion of the pipettor, and a spring that biases the ejector button in an uppermost position and also biases the ejector sleeve or stripper bar in its uppermost position, a method of transmitting ejection force from the ejection button to the ejector sleeve or stripper bar in order to eject the one or more pipette tips, comprising the steps of:
having one or more pipette tips mounted onto one or more mounting shafts of the pipettor with the ejector button being at its uppermost position in its range of motion;
biasing with spring force the ejector button and the ejector sleeve or stripper bar in their uppermost positions;
pressing the ejector button downward against the spring bias along its full range of motion;
transmitting the ejection force exerted on the ejector button to move the ejector sleeve or stripper bar downward against the spring biasing force and eject one or more pipette tips mounted to the respective mounting shafts, wherein the full range of motion of the ejector button is greater than the full range of motion of the ejector sleeve or stripper bar that directly engages the one or more pipette tips mounted on the one or more respective mounting shafts, and further wherein the transmitted ejection force provided by the ejector sleeve or stripper bar against the pipette tip is greater at a first portion of the range of motion of the ejector button than it is over a second portion of the range of motion of the ejector button.
